(19) United States
(12) Patent Application Publication
(10) Pub. No.: US 2011/0139882 A1
(43) Pub. Date: Jun. 16, 2011

(54) FUEL-OPERATED HEATING DEVICE AND VEHICLE HEATING SYSTEM

(75) Inventors: Roland KAINDL, Haimhausen (DE); Uwe Strecker, Inning (DE)

(73) Assignee: Webasto AG, Stockdorf/Gauting (DE)

(21) Appl. No.: 12/941,426

(22) Filed: Nov. 8, 2010

(30) Foreign Application Priority Data
Dec. 15, 2009 (DE) 10 2009 044 905.1

(51) Int. Cl. B60H 1/03

(52) U.S. Cl. 237/5; 237/12.3 C; 237/2 A

(57) ABSTRACT

A fuel-operated heating device is provided which is adapted to provide heat by conversion of fuel with combustion air. A control unit of the fuel-operated heating device is adapted to control operation of the fuel-operated heating device. The control unit of the fuel-operated heating device is adapted to control at least one electric heating element as a slave.

The present invention relates to a fuel-operated heating device and to a vehicle heating system comprising such a fuel-operated heating device.

It is known to heat an area to be heated of a vehicle, such as the interior of a motor vehicle, via a heat exchanger arrangement which is exposed to air to be heated, the air being supplied to the area to be heated. In conventional road vehicles having a combustion engine, typically waste heat of the combustion engine is used for heating. This is achieved by routing warm engine cooling liquid through a heat exchanger arrangement in which the heat is transferred to air to be heated. In efficient combustion engines, the released heat is often not sufficient for sufficiently heating the passenger compartment such that to some extent additional vehicle heating devices are used. Additional vehicle heating devices can be realized as auxiliary heaters which only provide heat while the drive engine is running or as parking heaters which can provide heat both when the drive engine is running and when it is in a stopped state. The additional vehicle heating devices can be formed such that they are integrated in the engine cooling liquid circuit and heat the engine cooling liquid.

In the case of thus-called hybrid vehicles comprising an electric driving motor and a combustion engine and in the case of electric vehicles comprising only an electric driving motor, the problem that enough waste heat for heating an area to be heated is not available in all operation states arises to a higher extent. If heating in such vehicles is performed using only electric heating elements (e.g. thus-called PTC elements), much of the electric energy stored in the vehicle is consumed which drastically reduces the remaining driving distance. On the other hand, use of fuel-operated heating devices and the corresponding emissions are subject to restrictions by law.

DE 100 25 713 A1 describes a heating system for motor vehicles comprising a first heating device being operated by means of a first energy source, a second heating device being operated by means of a second energy source, and a control arrangement controlling operation of the heating devices.

It is an object of the present invention to provide a fuel-operated heating device and a vehicle heating system with which improved heating management for heating of a vehicle is enabled.

The object is solved by a fuel-operated heating device with the following characteristics: The fuel-operated heating device is adapted to provide heat for heating by conversion of fuel with combustion air. The fuel-operated heating device comprises a control unit which is adapted to control operation of the fuel-operated heating device. The control unit of the fuel-operated heating device is adapted to control at least one electric heating element as a slave.

Electric heating element means an element consuming electric energy and converting it to provide heat. The electric heating element can e.g. be formed by an electric resistance heater releasing ohmic heat, such as a thus-called PTC element, or e.g. by a heating element providing heating by exploiting induction. The electric heating element is such an element which is provided for the purpose of providing heat for heating. “Controlling as a slave” means that the control unit of the fuel-operated heating device controls the electric heating element and, in doing so, exerts control on the electric heating element such that operation of the electric heating element is determined by the control unit of the fuel-operated heating device. “At least one electric heating element” means that a plurality of electric heating elements may also be provided. The electric heating elements of such a plurality can be controllable by the control unit of the fuel-operated heating device in common or separately in each case. By the combination of a fuel-operated heating device and at least one electric heating element, if required (e.g. in a city, in other zero-emission zones, or in a parking garage) emission-free heating can be provided, and where emissions of the fuel-operated heating device are admissible (e.g. outside of town or outside of other zero-emission zones) vehicle heating by means of the fuel-operated heating device can be provided in order to e.g. provide a large driving distance using an electric motor in the case of an electric vehicle or hybrid vehicle. Since the control unit of the fuel-operated heating device is adapted to control the electric heating element as a slave, switching to different heating operation modes can be performed in a simple manner in the control unit of the fuel-operated heating device, e.g. to a mode of zero-emission heating. Since the control unit of the fuel-operated heating device is adapted in such a manner, e.g. even in the case of retrofitting a fuel-operated heating device to a vehicle which already comprises an electric heating element, centralized heating management in the control unit of the fuel-operated heating device is enabled. In this way, e.g. vehicles which are only provided with electric heating elements can easily be retrofitted with a fuel-operated heating device and, in doing so, centralized heating management is provided. In the case of electric vehicles or hybrid vehicles, extension of the driving distance with the electric motor can be provided in this manner, since not only the electric storage elements in the vehicle have to be employed for heating.

According to one realization, the fuel-operated heating device comprises an interface for connecting at least one electric heating element or for connecting power electronics for at least one electric heating element. In this case, the fuel-operated heating device is formed such that at least one electric heating element (or several) or corresponding power electronics are directly connectable to the fuel-operated heating device via the interface. Thus, the control unit of the fuel-operated heating device can take over the function of centralized heating management in a compact and simple manner. In a simple manner, this realization allows retrofitting of a fuel-operated heating device to a vehicle already comprising electric heating elements.

According to one realization, the control unit is adapted to stop operation of the fuel-operated heating device and to control only the electric heating element in response to a signal. The signal for this switching can be provided e.g. by operating a switch in the vehicle or on a remote control for controlling the heating. However, it is also possible that the signal be e.g. automatically provided by a superior unit, e.g. when the vehicle moves into an area in which emissions of a fuel-operated heating device are inadmissible or undesired. In this realization, switching of the heating system to zero-emission operation can be performed centrally and conveniently in the control unit of the fuel-operated heating device. At the same time, the control unit can provide the necessary measures in order to effect desired heating using the at least one electric heating element.

According to one realization, the control unit is adapted to automatically stop operation of the fuel-operated heating device and to operate only the electric heating element when the control unit identifies that it is in a zero-emission zone. In this case, it is ensured that the fuel-operated heating device is not operated in areas in which emissions are inadmissible. Identification that the control unit is in a zero-emission zone can be performed e.g. via signal received by the control unit. For example, the respective signal can be provided by a superior control unit indentifying entry into a zero-emission zone, for instance via a positioning system, via radio frequency signals, or the like. For example, the signal can also be provided by a unit arranged in the fuel-operated heating device or in a superordinated vehicle heating system. Stopping operation of the fuel-operated heating device means that no further conversion of fuel with combustion air is performed in the fuel-operated heating device, thus that e.g. a burner of the fuel-operated heating device is stopped.

According to one realization, the control unit is adapted to simultaneously operate the fuel-operated heating device and the at least one electric heating element in the case of a demand for high heating power. In this case, by the fuel-operated heating device and by the at least one electric heating element high heating power can be provided in the case of a demand for high heating power. Further, e.g. immediately after starting of the burner of the fuel-operated heating device, when it does not yet provide sufficient heating power, heat of the electric heating element can be used to heat areas which are particularly sensible for security reasons, such as e.g. the front shield, side mirrors, etc.

According to one realization, the control unit is adapted to control a plurality of electric heating elements as slaves. In this case, the control unit of the fuel-operated heating device can be used as a central heating management unit for a complex system of heat sources.

The object is also solved by a vehicle heating system comprising the fuel-operated heating device and at least one electric heating element. In this case, the vehicle heating system comprises the fuel-operated heating device as well as at least one electric heating element such that, with the vehicle heating system, on the one hand, zero-emission heating is allowed when desired and, on the other hand, heating with the fuel-operated heating device is allowed without exploiting electric energy storages in the vehicle.

According to one realization, the fuel-operated heating device and the at least one electric heating element are arranged in one assembly unit. “Arranged in one assembly unit” means that the fuel-operated heating device and the at least one electric heating device (optionally several electric heating elements) are provided in one unit which is mountable in a vehicle in a compact manner and with little mounting work. In this case, a vehicle heating system is provided which comprises the above-described advantages and, at the same time, can be mounted with little work and requires only little space in the vehicle.

According to one realization, the fuel-operated heating device is arranged for heating a cooling liquid. In this case, the fuel-operated heating device can simultaneously be used to heat a vehicle driving motor (or engine) and/or electric components of a drive train and, via a cooling-liquid-to-air heat exchanger, also to heat air for heating e.g. a vehicle interior. According to one realization, the vehicle heating system comprises a cooling liquid circuit in which at least one electric component of the drive train is integrated and the fuel-operated heating device is arranged such that heating of at least one area to be heated and of the at least one electric component of the drive train is enabled via cooling liquid.

Further advantages and further developments will become apparent from the following description of an embodiment with reference to the accompanying drawings.

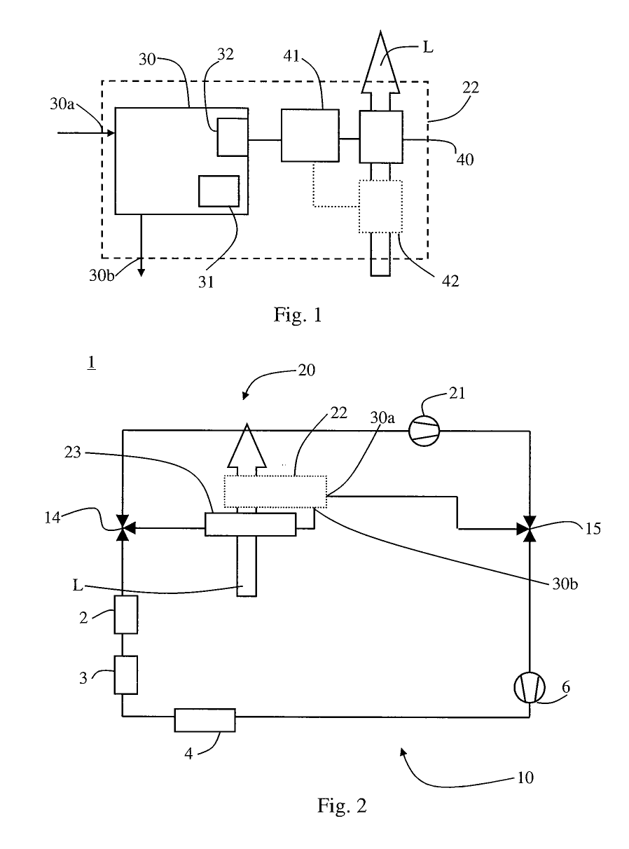

FIG. 1 is a schematic illustration of an assembly unit comprising a fuel-operated heating device according to one embodiment and an electric heating element having power electronics associated therewith.

FIG. 2 is a schematic illustration of a vehicle heating system comprising the fuel-operated heating device.

An embodiment of the present invention will be described in the following with reference to FIG. 1 and FIG. 2. First, a vehicle heating device 22 having a fuel-operated heating device 30, an electric heating element 40, and power electronics 41 for the electric heating element 41 will be described with reference to FIG. 1. In the embodiment shown, the components of the vehicle heating device 22 are formed as a compact assembly unit which is adapted to be mounted to a vehicle as one unit.

The fuel-operated heating device 30 is formed to be coupled to a cooling liquid circuit of a motor vehicle, in particular of an electro vehicle or hybrid vehicle. The fuel-operated heating device 30 is formed to transfer released heat to cooling liquid.

In the example shown, the electric heating element 40 is formed to transmit released heat directly to an air flow to be heated. For this purpose, the electric heating element is formed to be exposed to the air flow to be heated, as schematically shown by an arrow L in FIG. 1.

The fuel-operated heating device 30 is formed to provide heat for heating by conversion of combustion air and liquid or gaseous fuel. The fuel can e.g. be formed by benzine, diesel, ethanol, natural gas or by similar energy carriers. The fuel-operated heating device 30 is formed as a liquid heating device comprising a heat exchanger in which the released heat is transferred from hot exhaust gas to cooling liquid. In order to achieve this, the fuel-operated heating device 30 comprises a cooling liquid inlet 30a and a cooling liquid outlet 30b. The fuel-operated heating device 30 comprises a control unit 31 formed to control operation of the fuel-operated heating device 30. For this purpose, a control program is implemented in the control unit 31 in order to control the fuel-operated heating device 30 in different operation modes. In particular, the control unit 31 is formed to start the fuel-operated heating device, to keep it operating, and to stop its operation in a controlled manner. In particular, the control unit 31 is also formed to control a fuel supplying device for supplying the required fuel and a combustion air supplying device for supplying the required combustion air. In the embodiment, the control unit 31 is arranged in or on a casing of the fuel-operated heating device 30.

The fuel-operated heating device 30 further comprises an interface 32 for connecting to at least one electric heating element or for connecting to power electronics for at least one electric heating device. In the embodiment shown, the interface 32 is formed for connecting to power electronics 41 for the electric heating element 40. As shown in FIG. 1 by means of a further electric heating element 42 illustrated with broken lines, further electric heating elements can also be provided. Although it is shown in FIG. 1 that the further electric heating element 42 and the electric heating element 40 have common power electronics 41, separate power electronics can also be provided. As an alternative, it is also possible to provide the necessary power electronics directly in the fuel-operated heating device 30 such that electric heating elements can directly be connected to the interface 32 (without interconnected power electronics).

The control unit 31 of the fuel-operated heating device 30 is formed to also control operation of one or more electric heating element(s). In the following, this will exemplarily be described with respect to control of the electric heating element 40. The control unit 31 is adapted such that it controls the electric heating element 40 as a slave. Thus, the control unit 31 is formed to control the electric heating element 40 in a manner such that it determines operation of the electric heating element 40. This means in particular that the control unit 31 determines if the electric heating element 40 is switched on or off and, as the case may be, on which power level the electric heating element 40 is operated. For the case of several electric heating elements, the control unit 31 is formed to control several electric heating elements as respective slaves. The control unit 31 is adapted such that it can, in particular, start and stop operation of the fuel-operated heating device 30, i.e. the burner, the fuel supply device, and the combustion air supply device, and such that it also can start and stop operation of the electric heating element 40. The control unit 31 is formed such that it can either operate the burner of the fuel-operated heating device 30 or the electric heating device 40 or both simultaneously.

An exemplary integration of the described vehicle heating device 22 in a vehicle heating system 1 will in the following be described with reference to FIG. 2 on the basis of an application in an electric vehicle or hybrid vehicle. In the embodiment schematically shown in FIG. 2, the vehicle heating device 22 comprising the fuel-operated heating device 30 and the electric heating element 40 is integrated in a cooling liquid circuit of an electric vehicle or hybrid vehicle. In FIG. 2, the cooling liquid circuit is only schematically shown by means of several lines. Electric components of the drive train of the vehicle which in at least some operation states have to be actively heated are integrated in the cooling liquid circuit. Exemplarily, an electric motor 2, power electronics 3 associated therewith, and a traction battery 4 are illustrated in FIG. 2. Further, a cooling-liquid-to-air heat exchanger 23 which is formed to transfer heat from the cooling liquid to air to be heated, e.g. to air for a vehicle interior, is arranged in the cooling liquid circuit. Further, valves 14 and 15 as well as pumps 6 and 21 are provided in the cooling liquid circuit for circulating the cooling liquid. The components of the cooling liquid circuit are interconnected by connection lines, as schematically illustrated in FIG. 2.

The vehicle heating device 22 is integrated in the cooling liquid circuit such that cooling liquid heated by the fuel-operated heating device 30 can transfer heat to an air flow to be heated in the cooling liquid-to-air heat exchanger 23. In FIG. 2, a case is schematically indicated in which the air flow heated by the cooling liquid-to-air heat exchanger 23 corresponds to the air flow L heated by the electric heating element 40. However such a realization is not binding and it is also possible to heat different air flows. Further, it should be noted that the electric heating element 40 does not necessarily have to be formed for heating an air flow, but that it can also be formed as a surface heater (e.g. for a vehicle seat or the like) or can also be formed for heating cooling liquid.

In the example shown in FIG. 2, the valves 14 and 15 can be adjusted such that the cooling liquid heated by the fuel-operated heating device 30 is circulated in a first liquid circuit 10 via the cooling liquid-to-air heat exchanger 23, the electric motor 2, the power electronics 3 and the traction battery 4 by means of the pump 6, or such that the heated cooling liquid is circulated in a second liquid circuit 20 only via the cooling liquid-to-air heat exchanger 23 by means of the pump 21. When the cooling liquid is circulated in the first liquid circuit 10, the electric components (2, 3, 4) can be heated by the heat released by the fuel-operated heating device 30. When the cooling liquid is circulated in the second liquid circuit 20, the heat from the fuel-operated heating device 30 is only used for heating the air to be heated.

In FIG. 2, a cooling liquid circuit is shown in an extremely simplified manner. The cooling liquid circuit can, in particular, comprise further components and branches. Below others, for example further heat exchangers can be arranged in the cooling liquid circuit, e.g. in order to also enable cooling of the electric components (2, 3, 4) of the drive train.

In the following, the realization of the control unit 31 of the fuel-operated heating device 30 will be described in more detail. The control unit 31 is formed to fully control operation of both the fuel-operated heating device 30 and the electric heating element 40. For example, a provision can be realized in the control unit 31 that upon starting operation of the vehicle heating system and depending on different parameters (e.g. inside temperature, outside temperature) components which are relevant for security, such as the front shield and mirrors at cold temperatures, are first heated as fast as possible using the heating power of both the electric heating element 40 and the fuel-operated heating device 30. According to the embodiment, the control unit 31 is further adapted such that, when there is a demand for high heating power, the fuel-operated heating device 30 and the electric heating element 40 are simultaneously operated in order to provide the combined heating power of these heat sources.

In the embodiment, the control unit 31 is further adapted such that it stops operation of the burner of the fuel-operated heating device 30 and only controls the electric heating element 40 for heating purposes in response to a signal. In this way, the control unit 31 can thus switch the vehicle heating device 22 to a mode of operation in which the latter does not release any emissions (in particular no combustion exhaust gases).

In a simple realization, the signal for switching to zero-emission operation can e.g. be activated by an active input of a user, for instance by an input via a user interface such as a switch or button. However, it is also possible to configure the control unit 31 such that it automatically switches to the zero-emission operation mode upon identifying that the vehicle is in or moves into a zero-emission area (zero-emission zone). Automatic identification can e.g. be realized using a positioning system with which the position of the heating device 30 or of the vehicle is determined, wherein information about zero-emission areas is also deposited in the positioning system. As an alternative, it is e.g. also possible to trigger switching by e.g. radio frequency signals, optionally in combination with RFID components. However, many other possibilities exist.

By central realization of heating management in the control unit 31 of the fuel-operated heating device 30, efficient thermal management for a vehicle is provided. In particular, the control unit 31 can further be formed to evaluate e.g. information about the state of charge of electric energy storages in the vehicle or further parameters (inside temperature, outside temperature, etc.) and to control the burner of the fuel-operated heating device 30 and the electric heating element 40 based thereon.

According to an advantageous embodiment, the control unit 31 of the fuel-operated heating device 30 is also formed to control one or more blower(s) for distributing heated air in the vehicle or to control e.g. manifold devices for controlling air flows of the heated air.

Although it has been described with regard to the embodiment that the fuel-operated heating device 30 and the electric heating element 40 are combined to a compact assembly unit, the present invention is not restricted to this and it is e.g. also possible to provide the electric heating element 40 and the associated power electronics 41 separate from the fuel-operated heating device 30. However, it is e.g. also possible to combine the power electronics 41 and the fuel-operated heating device 30 in a compact assembly unit and form the electric heating element 40 separately. Although an embodiment has been described in which only one electric heating element 40 is provided, it is also possible that several electric heating elements (e.g. at different positions) are provided in a vehicle.

Further, the fuel-operated heating device can also be provided separately without electric heating elements and/or associated power electronics. In this case, the fuel-operated heating device can be provided as an optional equipment or aftermarket equipment for vehicles comprising one (or several) electric heating element(s).

Although in many instances only controlling of the electric heating element 40 is explicitly mentioned in the description of an embodiment, it has to be understood that several electric heating elements can be controlled in a corresponding manner.

1. Fuel-operated heating device being adapted to provide heat by conversion of fuel with combustion air, comprising
a control unit being adapted to control operation of the fuel-operated heating device,
characterized in that the control unit of the fuel-operated heating device is adapted to control at least one electric heating element as a slave.

2. Fuel-operated heating device according to claim 1, characterized in that the fuel-operated heating device comprises an interface for connecting at least one electric heating element or for connecting power electronics for at least one electric heating element.

3. Fuel-operated heating device according to claim 1, characterized in that the control unit is adapted to stop operation of the fuel-operated heating device and to control only the electric heating element in response to a signal.

4. Fuel-operated heating device according to claim 1, characterized in that the control unit is adapted to automatically stop operation of the fuel-operated heating device and to operate only the electric heating element when the control unit identifies that it is in a zero-emission zone.

5. Fuel-operated heating device according to claim 1, characterized in that the control unit is adapted to simultaneously operate the fuel-operated heating device and the at least one electric heating element in the case of a demand for high heating power.

6. Fuel-operated heating device according to claim 1, characterized in that the control unit is adapted to control a plurality of electric heating elements as slaves.

7. Vehicle heating system comprising a fuel-operated heating device according to claim 1 and at least one electric heating element.

8. Vehicle heating system according to claim 7 characterized in that the fuel-operated heating device and the at least one electric heating element are arranged in one assembly unit.

9. Vehicle heating system according to claim 7, characterized in that the fuel-operated heating device is arranged for heating a cooling liquid.

10. Vehicle heating system according to claim 7, characterized in that the vehicle heating system comprises a cooling liquid circuit in which at least one electric component of a drive train of a vehicle is integrated, and that the fuel-operated heating device is arranged such that heating of an area to be heated and of the at least one electric component of the drive train is enabled via cooling liquid.
